(19) United States
(12) Patent Application Publication
(10) Pub. No.: US 2026/0311221 A1
(43) Pub. Date: Oct. 8, 2026

(54) INFORMATION PROCESSING DEVICE

(71) Applicant: TOYOTA JIDOSHA KABUSHIKI KAISHA, Toyota-shi (JP)

(72) Inventors: Aya YAMADA KAMISAKA, Tokyo (JP); Takayuki YAMABE, Tokyo (JP); Kota HOSHIBA, Tokyo (JP); Ryota NAKANISHI, Tokyo (JP); Hajime TOJIKI, Tokyo (JP)

(73) Assignee: TOYOTA JIDOSHA KABUSHIKI KAISHA, Toyota-shi (JP)

(21) Appl. No.: 19/542,782

(22) Filed: Feb. 18, 2026

(30) Foreign Application Priority Data
Apr. 8, 2025 (JP) 2025-063788

(51) Int. Cl. G06Q 30/0282

(52) U.S. Cl. CPC G06Q 30/0282

(57) ABSTRACT

Included is a control unit that executes suggesting information to a user regarding a place to visit, regarding which visiting is recommended, obtaining position information of the user after the suggesting, and determining that the user exhibited reaction behavior in response to the suggesting of information regarding the place to visit, when determination is made that the user visited the place to visit, based on the position information that is acquired, and stay time of the user at the place to visit was longer than duration of a first threshold value.

### CROSS-REFERENCE TO RELATED APPLICATION

This application claims priority to Japanese Patent Application No. 2025-063788 filed on Apr. 8, 2025. The disclosure of the above-identified application, including the specification, drawings, and claims, is incorporated by reference herein in its entirety.

### BACKGROUND

### 1. Technical Field

The present disclosure relates to an information processing device.

### 2. Description of Related Art

When suggesting information to a user, it is useful to detect reaction behavior of the user with respect to the suggestion, from the perspective of improving accuracy of the suggestion of information, and so forth. In this regard, Japanese Unexamined Patent Application Publication No. 2022-144312 (JP 2022-144312 A), for example, discloses technology for estimating whether a user, who has come into contact with an advertisement, is interested in the advertisement. In this technology, when the user performs an action, such as searching for a related keyword, or the like, within a predetermined period after coming into contact with an advertisement, determination is made that the user has exhibited reaction behavior to the advertisement, i.e., that the user is interested in the advertisement.

### SUMMARY

It is not easy to detect a reaction of a user to a suggestion of information about a place to visit for the user, i.e., to detect whether the user actually visits the place to visit. Further, it is not easy to detect whether the reaction by the user was related to this place to visit.

It is an object of the present disclosure to suitably detect a reaction of a user with respect to a suggestion of information about a place to visit for the user.

One aspect of the present disclosure is an information processing device including a control unit that executes suggesting information to a user regarding a place to visit, regarding which visiting is recommended, acquiring position information of the user after the suggesting, and determining that the user exhibited reaction behavior in response to the suggesting of information regarding the place to visit, when determination is made that the user visited the place to visit, based on the position information that is acquired, and stay time of the user at the place to visit was longer than duration of a first threshold value.

Other aspects include a program that causes a computer to execute a method executed by the above information processing device, and a computer-readable storage medium that stores the program in a non-transitory manner.

According to the present disclosure, a reaction of a user, with respect to a suggestion of information about a place to visit for the user, can be suitably detected.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating an overview of an information suggestion system according to the present disclosure;

FIG. 2 is a diagram illustrating a hardware configuration of an in-vehicle device;

FIG. 3 is a diagram illustrating a software configuration of the in-vehicle device;

FIG. 4 is a first flowchart of processing for information suggestion that is executed by the in-vehicle device; and

FIG. 5 is a diagram illustrating cooperation among software modules included in the in-vehicle device, in the processing for information suggestion.

### DETAILED DESCRIPTION OF EMBODIMENTS

In recent years, advances in machine learning have increased the number of products equipped with language models. For example, a dialogue function by natural language can be added to a target product by incorporating into the product a large language model (LLM) of which accuracy has been improved through machine learning using a large-scale dataset. One field, in which dialogue by natural language is useful, is in automobiles. For example, equipping an in-vehicle device with an LLM enables information to be obtained without operating a touch panel or the like. Such a function is particularly useful when the hands of the user are occupied, such as while driving or the like. For example, a built-in device (e.g., in-vehicle device, etc.) within a vehicle may be equipped with a dialogue function by natural language. However, from the perspective of data size and cost of a trained LLM, a technique of accessing an LLM via a network can be employed instead. Accessing the LLM via a network enables large-scale language models that are difficult to install in local storage to be used.

Improvement of such dialogue functions by natural language has come to enable suggest various types of information to users, even when not limited to the use of natural language dialogue functions. Now, from the perspective of providing users with information suggestions that are suitable, understanding how the user reacts to the information suggestions provided thereto is considered as being important, but it is hard to say that favorable detection of such reactions is being implemented. In particular, when a suggestion is made to prompt a user to actually visit a certain place, i.e., when information about a place to visit that is recommended is suggested, detecting whether the user actually visits the place to visit is not easy. Further, even when the user visits this place to visit, detecting whether the user exhibited a favorable reaction to the place to visit is not easy, either.

The behavior of users after being provided with information suggestions about places to visit varies from user to user, and even when a user exhibits behavior that indicates interest in the information suggestion (e.g., making further inquiries about the place to visit, etc.), it is not certain that they will actually take actions to visit the place. Accordingly, the information processing device according to the present disclosure solves such problems.

An information processing device according to a first aspect of the present disclosure includes a control unit that executes suggesting information to a user regarding a place to visit, regarding which visiting is recommended, acquiring position information of the user after the suggesting, and determining that the user exhibited reaction behavior in response to the suggesting of information regarding the place to visit, when determination is made that the user visited the place to visit, based on the position information that is acquired, and stay time of the user at the place to visit was longer than duration of a first threshold value.

Suggesting information regarding places to visit to a user can take various forms. For example, an external agent disposed externally from the information processing device can be used. For example, the external agent may be a system that is capable of dialogue by natural language and that provides suggestion services using language models specialized for each of a plurality of domains (fields). The language model may be a large language model (LLM). A large language model is, for example, a language model trained to be capable of executing dialogue tasks in natural language. Examples of domains that external agents can handle include "route directions", "regional information guidance", "tourist guidance", and "shopping guidance". These external agents are typically configured to enable remote access via a network.

Alternatively, a local agent that the information processing device is equipped with can be used to suggest information to the user. The language model that the local agent has is a language model capable of executing dialogue tasks in natural language, but unlike an external agent, it can be a language model that has not been trained specifically for a particular domain and is generated at a relatively low cost, for example.

Position information of the user is information that enables detecting changes in position as the user travels. Position information of the user may be acquired using a Global Positioning System (GPS) function provided to a mobile device such as a smartphone or the like that is held by the user him/herself, or may be acquired using a GPS function provided to a moving object such as a vehicle in which the user is riding. The position information detected by these GPS functions is handed over to the information processing device, enabling the position information of the user to be acquired. That is to say, the information processing device acquires the position information of the user by using detection results from a device capable of detecting the movement of the user.

After the information is suggested to the user, the control unit then determines whether the user has visited the place to visit that has been suggested, based on the position information of the user that is acquired. When making this determination, when the position information of the user overlaps with the position information of a place to visit, or when the position information of the user is now in a state of belonging to a certain nearby region that is centered on the place to visit, for example, determination can be made that the user has visited the place to visit. On the other hand, when a user visits a place to visit that has been suggested, it is conceivable that the visit is based on a request of the user, which is the premise of the suggestion, and accordingly, granted that the visit is the result of the user reacting to the suggestion about the place to visit, it is reasonably anticipated that the user will stay at the place to visit for a certain duration of time in order to achieve the purpose of the visit. Accordingly, when the control unit determines that the user has visited the place to visit that has been suggested thereto, and the stay time of the user at the place to visit is longer than a first threshold value, the control unit determines that the visiting behavior of the user is a reaction behavior to the suggestion regarding the place to visit. Employing this configuration enables the information processing device to suitably detect the reaction of the user to the suggestion. Note that the first threshold value may be set based on a statistical value relating to stay time of people who have visited the place to visit in the past, or may be a value set by some other technique.

Also, when the place to visit that has been suggested is a place that is preferred by the user, the stay time of the user would generally tend to be a longer period of time. Accordingly, in the information processing device above, the control unit may further determine that the user exhibited favorable reaction behavior in response to the suggestion of information regarding the place to visit, when determination is made that the user visited the place to visit, and the stay time of the user at the place to visit was longer than duration of a second threshold value that is greater than that of the first threshold value. The second threshold value has a value greater than the first threshold value, and is preferably set based on statistical values regarding the stay time of people who have visited the place to visit in the past, and evaluations of the place to visit by those people. Employing this configuration enables the information processing device to suitably detect the reaction of the user to the suggestion.

Also, by detecting that the user has exhibited reaction behavior to a suggestion regarding a place to visit, and further detecting that the user has exhibited favorable reaction behavior to the suggestion, the control unit can accumulate the detection results and use these in the processing for suggesting places to visit in the future, thereby improving the suggestion processing.

Hereinafter, specific embodiments of the present disclosure will be described with reference to the drawings. The hardware configuration, module configuration, functional configuration, and so forth, described in each embodiment are not intended to limit the technical scope of the disclosure to these configurations alone, unless otherwise specified.

### First Embodiment

### System Overview

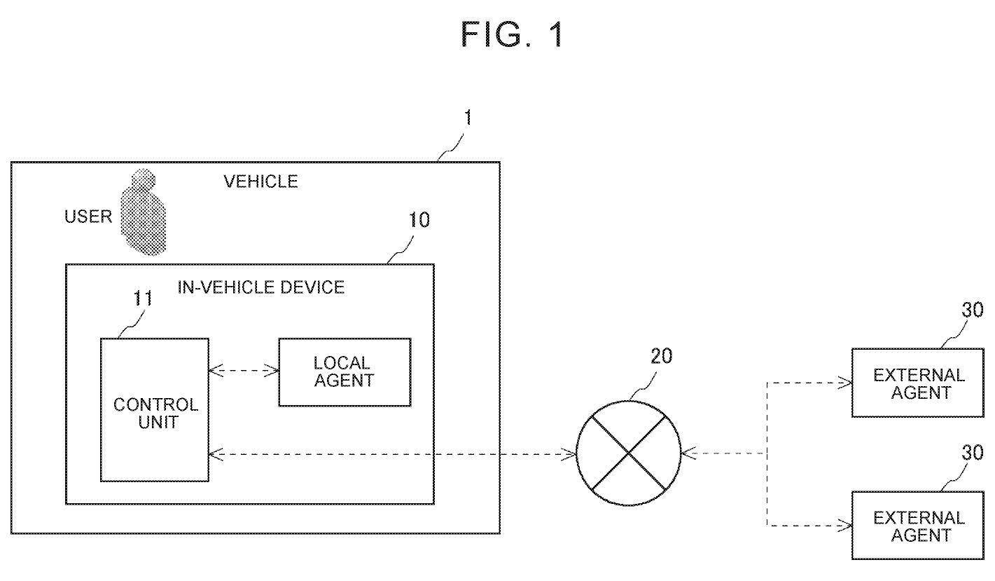

An outline configuration of a suggestion system according to a first embodiment will be described with reference to FIG. 1. The suggestion system according to the present embodiment is configured including an in-vehicle device 10 installed in a vehicle 1. The in-vehicle device 10 can access, via a network (e.g., a mobile communication network) 20, an agent (external agent 30) that provides a suggestion service for information in natural language.

The in-vehicle device 10 is installed in a connected vehicle that can communicate with various devices via wireless communication. The in-vehicle device 10 may include a data communication module (DCM) for connecting components of the vehicle 1 (e.g., electronic control units (ECUs), in-vehicle terminals, etc.) to the network 20. In the present embodiment, the in-vehicle device 10 can access the Internet via the network 20 by wireless communication, and connect to an external agent 30 or the like that provides a suggestion service.

The vehicle 1 (or components installed in this vehicle) can also provide various services by communicating with external devices via the in-vehicle device 10. Examples of such various services include navigation services, remote control (e.g., remote air conditioning, etc.) services, in-vehicle Wi-Fi (registered trademark) services, emergency call services, and so forth.

The in-vehicle device 10 further has a speech input and output function and is capable of engaging in dialogue in natural language with occupants of the vehicle. The in-vehicle device 10 is configured including a control unit 11 that performs speech input and output, and speech recognition, and a local agent. The local agent includes a language model trained to enable dialogue in natural language. For example, the local agent may provide a predetermined function such as route searching, operation of the vehicle (air conditioning, etc.), and so forth, through dialogue. Further, the local agent is configured to be capable of providing suggestion services for information in natural language, similar to the external agent 30. Note that the language model used by the local agent is stored in a storage device of the in-vehicle device 10.

Now, the size of a language model used in a suggestion service for information through dialogue in natural language varies greatly depending on functions thereof. For example, there are a wide variety of dialogue categories, such as regional information, tourist guidance, shopping guidance, and so forth, and in order to cover all of these categories, preparing a language model trained using large-scale training data becomes necessary. Such language models can range in size from several gigabytes to several hundred gigabytes, making installation thereof, in the in-vehicle device 10, which has limited storage capacity, difficult. Accordingly, the suggestion service function using a large-scale language model is set in the external agent 30. On the other hand, the in-vehicle device 10 is equipped with a relatively small language model, which is used by a local agent to realize, for example, a suggestion service for information in natural language in response to requests from limited users.

Note that in the description of the present embodiment, the expressions "access an external agent" and "connect to an external agent" refer to accessing or connecting to an external device that provides the suggestion service via the external agent. In the present embodiment, each of a plurality of suggestion services using large language models is operating as an "external agent" on a corresponding one of a plurality of external devices, and the in-vehicle device 10 can engage in dialogue by connecting to any of these external agents.

### Hardware Configuration

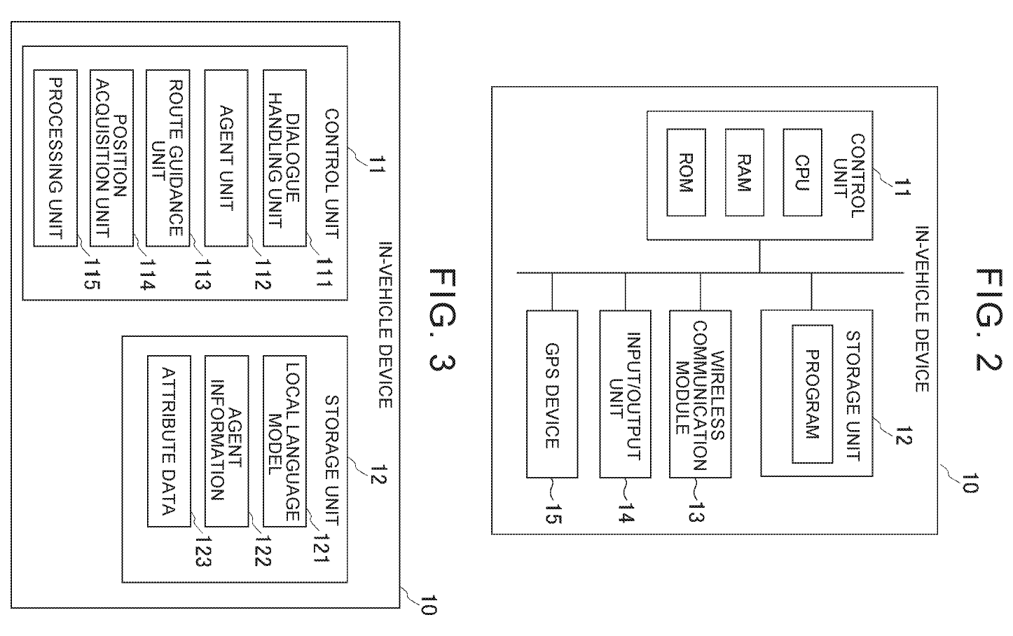

Next, the hardware configuration of each device making up the suggestion system will be described. FIG. 2 schematically illustrates an example of the hardware configuration of the in-vehicle device 10 according to the present embodiment.

The in-vehicle device 10 can be configured as a computer that includes a processor (a central processing unit (CPU), a graphics processing unit (GPU), or the like), a main storage device (random-access memory (RAM), read only memory (ROM), or the like), and an auxiliary storage device (erasable programmable read only memory (EPROM), a hard disk drive, a removable medium, etc.). An operating system (OS), various types of programs, various types of tables, and so forth, are stored in the auxiliary storage device, and the programs that are stored therein are executed, whereby various functions (software modules) can be realized to meet predetermined purposes, which will be described later. However, part or all of the functions may alternatively be realized as hardware modules by using hardware circuits such as, for example, application-specific integrated circuits (ASICs), field-programmable gate arrays (FPGAs), and so forth.

The in-vehicle device 10 is configured including, as hardware, a control unit 11, a storage unit 12, a wireless communication module 13, an input/output unit 14, and a GPS device 15.

The control unit 11 is a computing unit that realizes various functions of the in-vehicle device 10 by executing predetermined programs. The control unit 11 can be realized by, for example, a hardware processor such as a CPU or the like. Also, the control unit 11 may be configured including RAM, ROM, cache memory, and so forth.

The storage unit 12 is means for storing information, and is made up of a storage medium such as RAM, a magnetic disk, flash memory, or the like. The storage unit 12 stores programs executed by the control unit 11, data used by the programs, and so forth.

The wireless communication module 13 is a communication device that performs wireless communication with a predetermined network. In the present embodiment, the wireless communication module 13 is configured to be able to communicate with the network 20, which is a mobile communication network. The wireless communication module 13 can be configured having an embedded Universal Integrated Circuit Card (eUICC) (e.g., a Subscriber Identity Module (SIM) card). The SIM card is configured as a microcomputer that includes a CPU and a storage device. The SIM card stores information for connecting to the network 20 and receiving authentication.

The input/output unit 14 is a unit that receives input from a user of the device and presents information to the user. The input/output unit 14 typically includes devices that input and output audio, such as a microphone and a speaker. The input/output unit 14 may also include a device that provides visual information (display, etc.).

The GPS device 15 is a unit that acquires position information of the vehicle 1 using GPS functions. It should be noted that with respect to a user riding in the vehicle 1, the position information of the vehicle 1 detected by the GPS device 15 is treated as information equivalent to position information of the user.

### Software Configuration

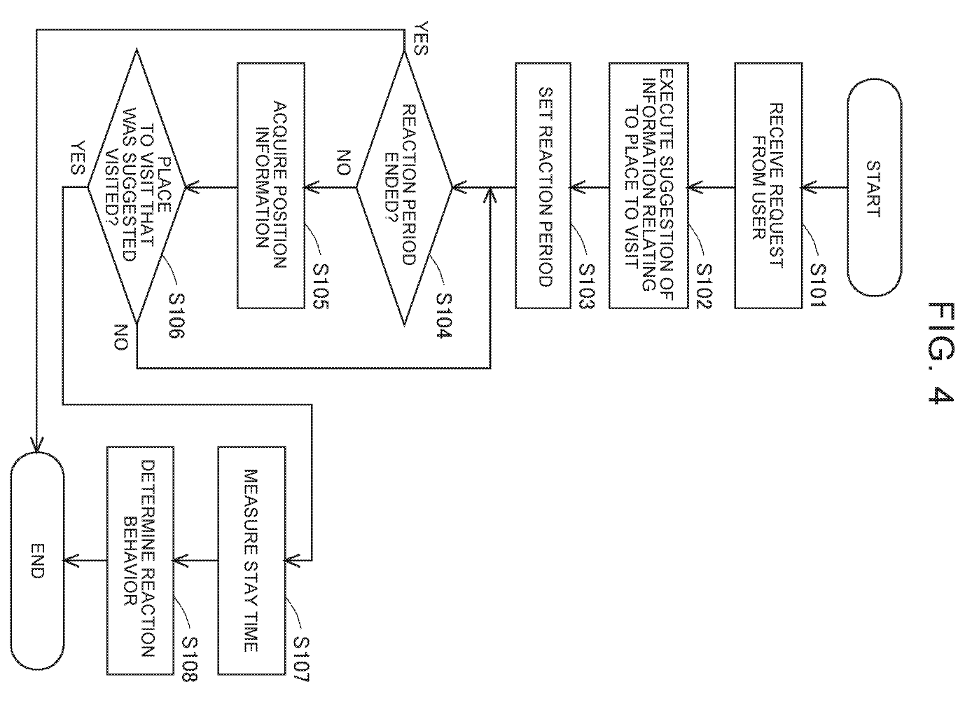

Next, the software configuration of the devices making up system will be described. FIG. 3 is a diagram that schematically illustrates the software configuration of the in-vehicle device 10 according to the present embodiment. In the present embodiment, the control unit 11 of the in-vehicle device 10 is configured having five software modules, which is a dialogue handling unit 111, an agent unit 112, a route guidance unit 113, a position acquisition unit 114, and a processing unit 115. Each of the software modules may be realized by the control unit 11 (CPU, etc.) executing a program stored in the storage unit 12. Note that the information processing executed by the software modules is equivalent to the information processing executed by the control unit 11 (CPU, etc.).

The dialogue handling unit 111 acquires an utterance made by a vehicle occupant (hereinafter also referred to as "user") via the input/output unit 14. The dialogue handling unit 111 performs predetermined processing on the acquired voice data, and performs speech recognition. The content of the utterance is thus converted into text. The dialogue handling unit 111 then transmits the text obtained as a result of the speech recognition, to the agent unit 112. The dialogue handling unit 111 also outputs a response (hereinafter referred to as "reply sentence") from the language model transmitted from the agent unit 112 in the form of speech or display.

The agent unit 112 provides a suggestion service for information. In particular, in the present embodiment, the agent unit 112 executes processing of suggesting information about recommended places to visit. Specifically, the agent unit 112 provides a suggestion service for information using a language model (local language model 121, which will be described later) stored in the device itself. The agent unit 112 can behave as a virtual agent (local agent). The local agent can provide, for example, a suggestion service that can be completed within the device itself (e.g., casual conversation, etc.). Furthermore, when specialized knowledge is required in a dialogue, the agent unit 112 transmits an utterance sentence to one or more external agents 30, that are available, via the network 20, acquires results thereof, and provides the results to the user, thereby realizing the suggestion service for information. For example, when determination is made that the user is seeking information about recommended places to visit by the vehicle 1, to go sightseeing, the agent unit 112 selects an external agent 30 that can provide tourist guidance. Also, when determination is made that the user is seeking information regarding facilities or shops, the agent unit 112 selects an external agent 30 capable of providing information regarding such facilities or the like. The selection of the external agent 30 may be performed based on the result of analyzing the content of the utterance. For example, the agent unit 112 may calculate a relevance score for each of the external agents 30 based on words or the context included in the utterance sentence, and transmit the utterance sentence to an external agent 30 of which the obtained relevance score is a predetermined value or higher.

The route guidance unit 113 accepts specification of a starting point and a destination from the user, or receives an instruction from the agent unit 112 (e.g., instruction to set position information of a destination or the like that is recommended to the user), and generates a route connecting the starting point and the destination based on road map data, and so forth. Information regarding the generated route is also output via the input/output unit 14.

The position acquisition unit 114 acquires position information relating to the movement of the user via the GPS device 15. As described above, the user is riding in the vehicle 1 and the GPS device 15 is disposed in the vehicle 1, and accordingly, in the present embodiment, the position information detected by the GPS device 15 is treated as information that can be equated with the position information of the user. Alternatively, when a mobile device of the user, such as a smartphone or the like, is equipped with a GPS function, the position acquisition unit 114 can acquire position information regarding movement of the user via this mobile device.

The processing unit 115 determines, based on the position information of the user that is acquired by the position acquisition unit 114, whether the user has actually visited the places to visit suggested by the agent unit 112. When determination is made that the user has visited the place to visit that is suggested, determination is then made regarding whether the user has exhibited reaction behavior with respect to the suggestion, based on the stay time of the user at that place to visit. The stay time of a user at a place to visit can be calculated using changes in the position information of the user. For example, the time during which the position of the user is within a nearby area, that is centered on the place to visit, may be taken as the stay time, or other forms of calculating the stay time may be employed. Further, the processing unit determines whether the reaction behavior of the user with respect to the suggestion was favorable based on the stay time, and evaluates the suggestion service. Processing by the processing unit 115 will be described in detail later.

Also, the storage unit 12 of the in-vehicle device 10 stores the local language model 121, agent information 122, and attribute data 123. The local language model 121 is a language model trained to enable execution of dialogue tasks in natural language. The local language model 121 is a language model that can be generated at a relatively low cost, and, for example, a language model for general-purpose conversation is sufficient. The local language model 121 is a lightweight language model as compared to the large language models that the external agents that are accessible via the network are provided with. The use of the local language model 121 by the agent unit 112 enables dialogue with lively responsivity. This enables differentiation in way of use, such as for example, when specialized conversation is required, utterance sentences can be transmitted to an external agent, while when conversations require a quick response, the local agent can perform processing of the utterance sentences.

The agent information 122 is a set of data regarding the multiple external agents available to the in-vehicle device 10. The agent information 122 may include, for example, identifiers and names of the external agents, information regarding domains in which the external agents are specialized, information regarding access destinations (e.g., network addresses and so forth of external devices that provide external agents), and so forth. The agent unit 112 can reference the agent information 122 to decide the external agent to which the utterance sentence is to be transmitted.

The attribute data 123 is a set of data relating to attributes of the user who engages in dialogue with the in-vehicle device 10. The attribute data 123 may include personal information such as, for example, the gender, age, height, and weight, and so forth, of the user. Also, when there is a plurality of users of the vehicle, the attribute data 123 may also include data for each of the users.

Flow of Information Suggestions to Users and Detection of User Reaction Behavior

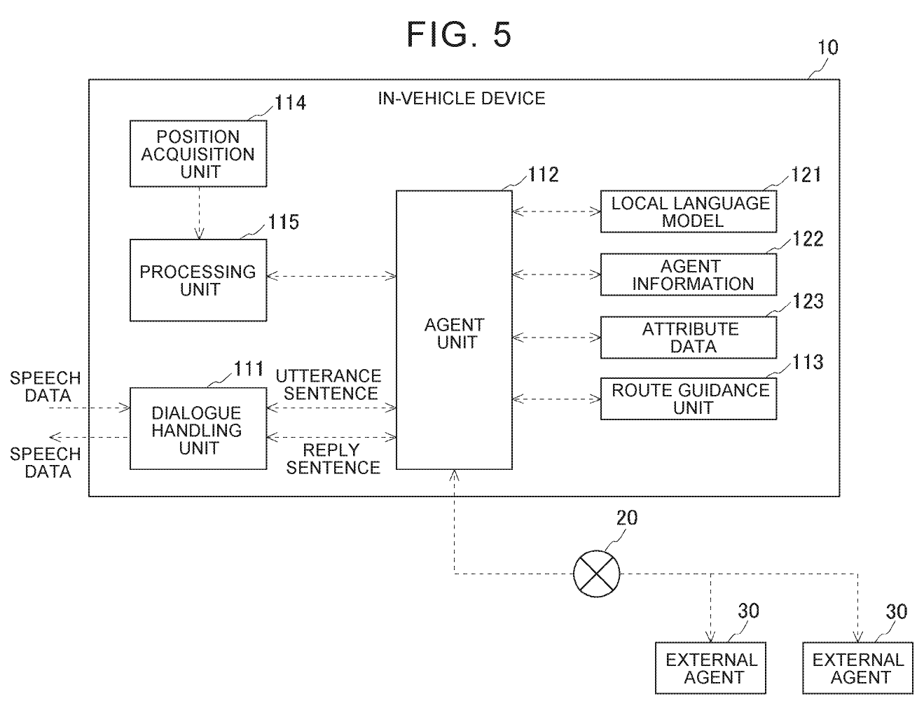

Now, FIG. 4 is a flowchart showing a processing flow for suggesting information to the user about places to visit, and FIG. 5 is a diagram illustrating cooperation of each software module in the control unit 11 of the in-vehicle device 10 in this processing of the information suggestions. The flow of processing executed by the control unit 11 will be described with reference to these diagrams. Note that the processing shown in the flowchart of FIG. 4 starts, in one example, when the user makes a request to the in-vehicle device 10 (request for information suggestions regarding places to visit).

First, in S101, a request for information suggestions regarding places to visit from a user riding in the vehicle 1 is accepted. This processing is performed by the dialogue handling unit 111. Specifically, the dialogue handling unit 111 acquires a request-related utterance from the user via the input/output unit 14. For example, the input/output unit 14 converts an utterance acquired through a microphone or the like into voice data, and the dialogue handling unit 111 acquires the voice data. The dialogue handling unit 111 performs predetermined speech recognition processing on the voice data that is acquired, to convert this voice data into text. While a response to the utterance on hold, the dialogue handling unit 111 transmits the text obtained as a result of the speech recognition to the agent unit 112. This text is referred to as "utterance sentence".

Next, in S102, the agent unit 112 executes processing of suggesting information based on the utterance sentence transmitted by the dialogue handling unit 111. Specifically, the agent unit 112 receives the utterance sentence and comprehends the request of the user (request such as the type of place the user wants to visit, etc.) based on the content of the utterance, and also acquires the agent information 122 relating to external agents from the storage unit 12, and then uses this agent information 122 to decide which external agent 30 to transmit the utterance sentence to. The intent of the utterance may be determined using the local language model 121, or may be determined using another machine learning model. The intent of the utterance may alternatively be determined using a rule-based approach. The agent unit 112 acquires information regarding the external agent (agent information 122) from the storage unit 12, and decides which external agent to transmit the utterance sentence to, based on the agent information 122 and the intent that is determined. Also, the agent unit 112 may also determine that it is not necessary to transmit the utterance sentence to an external agent. In such a case, processing of this utterance sentence may be performed just by the agent unit 112 (and local language model 121).

In this example, the following two exemplify the external agents 30.

(1) Tourist guidance agents

These are external agents that can provide information regarding traveling directions for the user, including tourist guidance.

(2) Shopping guidance agents

These are external agents that can provide information regarding traveling directions for the user, including shop guidance.

In this example, a situation will be considered in which the tourist guidance agent is decided as the external agent that corresponds to the information suggestion.

Note that when transmitting the utterance sentence to the external agent 30 that has been decided upon, the agent unit 112 adds information about the user. The information about the user may include personal information such as, for example, the gender, age, height, and weight, of the user. Such information may be acquired from the attribute data 123 stored in the storage unit 12. Also, information about the user may also include travel information regarding the user. Examples of such information include information regarding the departure point, destination, travel route, waypoints, and so forth, of the vehicle 1. Such information may be acquired from the route guidance unit 113. The external agent 30 that has been decided upon can generate a response to a request from the user based on this information. For example, the external agent 30 generates a response recommending that the user visit tourist spot X located near the destination of the vehicle 1. In this case, the place to visit is "tourist spot X".

The response generated by the external agent 30 is transmitted as a reply sentence to the agent unit 112, and the agent unit 112 uses this as a reply to the request and performs processing to suggest information to the user regarding places to visit, via the dialogue handling unit 111. Specifically, the dialogue handling unit 111 generates speech data based on the reply sentence, and performs output thereof via the input/output unit 14. Note that the dialogue handling unit 111 may generate just the speech data for reading out the reply sentence, or may also additionally generate information to accompany the speech data. An example of information accompanying the speech data is a user interface screen. This user interface screen may include the reply sentence in written form.

Next, in S103, the processing unit 115 sets a reaction period. This reaction period is a period set to detect whether the user has exhibited reaction behavior with respect to the processing of suggesting information regarding places to visit executed in S102, and is a predetermined period starting immediately after the suggestion processing. For example, the reaction period may be set to one week, or may be set to any other period.

Next, in S104, determination is made regarding whether the reaction period set in S103 has ended. Note that the starting point of the reaction period is the time when the suggestion processing in S102 is executed, and in S104, determination is made regarding whether the reaction period has elapsed since that point. When the determination in S104 is affirmative, the processing of suggesting information about places to visit shown in FIG. 4 ends, and when the determination is negative, the processing advances to S105.

In S105, the position acquisition unit 114 acquires position information of the user. As described above, in the present embodiment, the position information of the vehicle 1 is treated as the position information of the user riding in the vehicle. The position information of this user is handed from the position acquisition unit 114 to the processing unit 115. When the processing of S105 ends, the processing advances to S106.

In S106, the processing unit 115 determines whether the user has visited a place to visit that was suggested by the agent unit 112 (e.g., aforementioned tourist spot X) based on the position information of the user acquired in S105. Specifically, when determination can be made that the position information of the user indicates that the user is located within a region of a predetermined radius centered on the tourist spot X, determination can be made that the user has visited this place to visit. Note that the predetermined radius can be adjusted as appropriate, in accordance with the characteristics of the place to visit. For example, when the place to visit is a building in an urban setting, the predetermined radius may be set to be relatively small, whereas when the place to visit is a park in the suburbs, the predetermined radius may be set to be larger, taking into account the size of this park, and so forth. When the determination in S106 is affirmative, the processing advances to S107, and when the determination is negative, the processing of S104 and thereafter is repeated.

In S107, the processing unit 115 measures the stay time of the user at the place to visit. Specifically, based on the position information of the user, the duration of the position of the user continuously staying within the above-mentioned region (e.g., a region within a predetermined radius centered on a tourist spot) is measured. In principle, when the position of the user departs from this region, it is reasonable to interpret that the state of staying of the user has ended, but when the duration of the departure is relatively brief (e.g.,

shorter than a predetermined threshold value duration), this departure may be ignored and the stay time of the user may be measured as though the state of staying was continuous. This takes into consideration the accuracy of acquiring the position information and the appropriateness of the region that is set. When the processing of S107 ends, the processing advances to S108.

In S108, the processing unit 115 performs determination processing regarding the reaction behavior of the user to the information suggestion regarding the place to visit, based on the stay time measured in S107. Specifically, when the stay time of the user is longer than the duration indicated by a first threshold value, the processing unit 115 determines that the user has exhibited reaction behavior with respect to this information suggestion. The first threshold value is set based on a statistical value regarding the stay time at the suggested place to visit by people who have visited this place to visit in the past. For example, when the place to visit is the tourist spot X, the first threshold value can be set to time that is 50% of the average value of the stay time of past visitors at tourist spot X. When a reply from the external agent 30 includes information about a such a place to visit, such statistical values (e.g., average values) regarding the place to visit may be included together with information regarding the place to visit, as well as information about the statistical values regarding the stay time there. The agent unit 112 that has received the reply from the external agent 30 suggests information about the places to visit to the user via the dialogue handling unit 111, and hands information of the statistical values to the processing unit 115 in preparation for the processing of S108. Alternatively, the processing unit 115 may access an external device other than the external agent 30 via the network 20 to search for information regarding places to visit and collect information about the stay time at these places to visit.

In the above example, the first threshold value is set for each suggested place to visit, but alternatively, the first threshold value may be set for each type of place to visit (e.g., outdoor facilities, indoors, etc.).

Further, when the stay time of the user is longer than a second threshold value that is greater than the first threshold value, the processing unit 115 determines that the user has exhibited favorable reaction behavior with respect to this information suggestion. This determination is based on the concept that the longer the stay time of a user is, the more favorable the reaction of the user to the places to visit is. The second threshold value is set based on a statistical value regarding the stay time at the suggested place to visit by people who have visited the place to visit in the past, and evaluations by the visitors regarding this place to visit. Statistical values regarding the stay time are as described above. Regarding evaluation of the places to visit by the visitors, information regarding the place to visit and statistical value information about the stay time there may also be included along with information about the evaluation, in the reply from the external agent 30 regarding the place to visit. The second threshold value can then be set based on the correlation between the stay time and the evaluation results regarding the place to visit. For example, when a significant amount of stay time can be extracted, by which determination can be made to indicate favorable reaction behavior in the correlation between the stay time and the evaluation results, the lower limit value of that stay time may be set as the second threshold value. Alternatively, when accessing an external device other than the external agent 30 via the network 20, the processing unit 115 may search for information regarding the place to visit, collect information regarding the stay time and evaluation, and set the second threshold value based on the collected results.

Note that when the stay time of the user is longer than the duration of the second threshold value, but the place to visit that is suggested is a place that belongs to a predetermined category regarding which it is difficult to find a correlation between the stay time and favorable evaluation by the user, the processing unit 115 does not have to determine that the user has exhibited favorable reaction behavior with respect to the information suggestion. For example, when the places to visit that are suggested are places such as restaurants, beauty salons, and so forth, at which the user evaluations tend to be based on the quality of services provided there, it is conceivable that finding a correlation between the stay time and favorable evaluation by the user will be difficult. When such a place to visit is suggested, whether the user exhibits favorable reaction behavior is not determined based on the second threshold value.

In this way, according to the processing shown in FIG. 4, the reaction of the user to the suggestion of information regarding places to visit to the user can be suitably detected. Also, the processing results by the processing unit 115, i.e., information regarding whether the user has exhibited reaction behavior with respect to suggestions regarding places to visit and whether the user has exhibited favorable reaction behavior with respect to the suggestions, may be accumulated in the in-vehicle device 10. The agent unit 112 then uses the processing results when making suggestions on information regarding future places to visit, thereby enabling realization of even more suitable information suggestions.

Also, although a reaction period is set in the processing shown in FIG. 4, the reaction period does not necessarily have to be set. In this case, after the suggestion processing regarding a place to visit is performed, the processing of S107 and S108 is performed, starting from the point of detecting that the user has visited the place to visit.

### Modifications

The above-described embodiment is merely an example, and the present disclosure may be appropriately modified and implemented without departing from the scope thereof. For example, the processing and means described in the present disclosure can be carried out freely combined insofar as no technical contradiction occurs. For example, the information processing device according to the present disclosure may be configured as a server device that is disposed in an immovable form, rather than as an in-vehicle device that is installed in a vehicle. In this case, the disclosure described in the first embodiment can be applied to the present modification.

Also, while a form in which the external agents are deployed on the external devices connected to the Internet has been exemplified in the embodiment, the external agents may instead be deployed on other types of devices. For example, the external agents may be deployed on an edge server that is accessible from the vehicle. The external agents may alternatively be deployed distributed across a plurality of edge servers or in the cloud. Also, the in-vehicle device 10 is exemplified as the information processing device according to the present disclosure in the embodiment, but the information processing device can also be implemented as a device or as equipment that is not installed in a vehicle.

Note that when the external agents are deployed across a plurality of edge servers or the like, the in-vehicle device 10 may acquire position information of the own vehicle and identify, based on the position information, an edge server on which the desired external agent is deployed. For example, external agents that provide regional information may be deployed on a plurality of edge servers, each of which is deployed in a different region. In such a case, the in-vehicle device 10 may, for example, identify the external agent deployed on the edge server that is geographically closest, based on the position information of the own vehicle. The regional information handled by the external agents may differ from one edge server to another. For example, an external agent that provides regional information for Area A may be deployed on an edge server located in Area A, and an external agent that provides regional information for Area B may be deployed on an edge server located in Area B. The in-vehicle device 10 can identify the edge server corresponding to the area in which the own vehicle is located, and obtain regional information (information relating to places to visit) for that area by accessing the external agent provided by that edge server.

Also, processing described as being carried out by one device may be shared among and carried out by a plurality of devices. Alternatively, processing described as being carried out by different devices may be carried out by one device. In a computer system, what sort of hardware configuration (server configuration) is used to realize each function can be flexibly changed.

The present disclosure can also be realized by supplying a computer with a computer program that implements the functions described in the above embodiment, and causing one or more processors of the computer to read and execute the program. Such a computer program may be provided to the computer by a non-transitory computer-readable storage medium connectable to a system bus of the computer, or may be provided to the computer via a network. Examples of a non-transitory computer-readable storage medium include a disc of any type such as a magnetic disc (floppy (registered trademark) disc, hard disk drive (HDD), etc.), an optical disc (compact disc (CD)-read-only memory (ROM), digital versatile disc (DVD), Blu-ray disc, etc.), ROM, RAM, EPROM, electrically erasable programmable read only memory (EEPROM), a magnetic card, flash memory, an optical card, and any type of medium suitable for storing electronic commands.

What is claimed is:

1. An information processing device comprising:
a control unit that executes
suggesting information to a user regarding a place to visit, regarding which visiting is recommended,
acquiring position information of the user after the suggesting, and
determining that the user exhibited reaction behavior in response to the suggesting of information regarding the place to visit, when determination is made that the user visited the place to visit, based on the position information that is acquired, and stay time of the user at the place to visit was longer than duration of a first threshold value.

2. The information processing device according to claim 1, wherein the control unit further determines that the user exhibited favorable reaction behavior in response to the suggesting of information regarding the place to visit, when determination is made that the user visited the place to visit, and the stay time of the user at the place to visit was longer than duration of a second threshold value that is greater than the duration of the first threshold value.

3. The information processing device according to claim 2, wherein the control unit does not determine that the user exhibited favorable reaction behavior when the stay time of the user at the place to visit is longer than the duration of the second threshold value, but the place to visit is a place belonging to a predetermined category.

4. The information processing device according to claim 1, wherein the first threshold value is set based on a statistical value regarding stay time by people who visited the place to visit in past.

5. The information processing device according to claim 2, wherein the second threshold value is set based on a statistical value regarding stay time by people who visited the place to visit in past, and evaluations relating to the place to visit by the people who visited the place to visit.
